(19) United States
(12) Patent Application Publication
(10) Pub. No.: US 2023/0316090 A1
(43) Pub. Date: Oct. 5, 2023

(54) FEDERATED LEARNING WITH TRAINING METADATA

(71) Applicant: QUALCOMM Incorporated, San Diego, CA (US)

(72) Inventors: Avijit CHAKRABORTY, San Diego, CA (US); Prathamesh Kalyan MANDKE, San Diego, CA (US); Joseph Binamira SORIAGA, San Diego, CA (US); Kristopher URQUHART, Poway, CA (US)

(21) Appl. No.: 18/153,687

(22) Filed: Jan. 12, 2023

Related U.S. Application Data
(60) Provisional application No. 63/268,751, filed on Mar. 1, 2022.

(51) Int. Cl. G06N 3/098; G06F 9/54

(52) U.S. Cl. CPC G06N 3/098; G06F 9/54

(57) ABSTRACT

Certain aspects of the present disclosure provide techniques and apparatus for performing federated learning. One example method generally includes sending model update data to a server, generating training metadata using a trained local machine learning model and local validation data, and sending the training metadata to the server. The trained local machine learning model generally incorporates the model update data and global model data defining a global machine learning model, and the training metadata generally includes data bout the trained local machine learning model used to determine when to discontinue federated learning operations for training the global machine learning model. Another example method generally includes sending a global model to a federated learning client device and receiving training metadata from the federated learning client device.

### CROSS-REFERENCE TO RELATED APPLICATIONS

This application claims priority to and benefit of U.S. Provisional Pat. Application Serial No. 63/268,751, entitled “Federated Learning with Training Metadata,” filed Mar. 1, 2022, and assigned to the assignee hereof, the entire contents of which are hereby incorporated by reference.

### INTRODUCTION

Aspects of the present disclosure relate to training and updating machine learning models using federated learning techniques.

Machine learning is generally the process of producing a trained model (e.g., an artificial neural network, a tree (such as a decision tree or series of decision trees in a gradient boosting model), or other structures), which represents a generalized fit to a set of training data. Applying the trained model to new data produces inferences, which may be used to gain insights into the new data and to trigger the execution of various actions based on these insights.

As the use of machine learning has proliferated in various technical domains for what are sometimes referred to as artificial intelligence tasks, the demand for more efficient processing of machine learning model data has arisen. For example, “edge processing” devices, such as mobile devices, always-on devices, internet of things (IoT) devices, and the like, have to balance the implementation of advanced machine learning capabilities with various interrelated design constraints, such as packaging size, native (local) compute capabilities, power storage and use, data communication capabilities and costs, memory size, heat dissipation, and the like.

Federated learning is a distributed machine learning framework that enables a number of clients, such as edge processing devices, to train a shared global model collaboratively without transferring their local data to a remote server. Generally, a central server coordinates the federated learning process, and each participating client communicates only model parameter information with the central server while keeping its local data private. This distributed approach helps with the issue of client device capability limitations (because training is federated) and also mitigates data privacy concerns in many cases.

At least some conventional federated learning approaches are not able to track actual global model performance during training because the central server does not have access to the training data used by federated clients with which to test the global model. This may lead to additional, unnecessary training epochs, which wastes resources, as well as a general lack of understanding of the actual performance of the global model (e.g., whether the model is appropriately generalized across data, or whether the model is underfit or overfit relative to the training data set).

### BRIEF SUMMARY

Certain aspects provide a computer-implemented method, comprising: sending model update data to a server; generating training metadata using a trained local model and local validation data, wherein: the trained local machine learning model incorporates the model update data and global model data defining a global machine learning model, and the training metadata comprises data about the trained local machine learning model used to determine when to discontinue federated learning operations for training the global machine learning model; and sending the training metadata to the server.

Further aspects provide a computer-implemented method, comprising: receiving model update data from a federated learning client; and receiving training metadata from the federated learning client, wherein the training metadata comprises data about a trained local machine learning model incorporating the model update data at the federated learning client used to determine when to discontinue federated learning operations for training a global machine learning model.

Further aspects provide a computer-implemented method, comprising: generating training metadata using a global machine learning model and local validation data; and sending the training metadata to a server, wherein the training metadata comprises data about the global machine learning model used to determine when to discontinue federated learning operations for training the global machine learning model.

Further aspects provide a computer-implemented method, comprising: sending a global machine learning model to a federated learning client device; and receiving training metadata from the federated learning client device, wherein the training metadata comprises data about a trained local machine learning model used to determine when to discontinue federated learning operations for training the global machine learning model.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example federated learning architecture.

FIG. 2 depicts an example of generating training metadata during federated learning, according to aspects of the present disclosure.

FIG. 3 depicts an example process of pipelining federated learning when generating training metadata, according to aspects of the present disclosure.

FIG. 4 depicts an example process for generating training metadata using client devices that perform model validation, according to aspects of the present disclosure.

FIGS. 5A and 5B depicts an example method of performing federated learning with training metadata, according to aspects of the present disclosure.

FIGS. 6A and 6B depict example processing systems that may be configured to perform the methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for generating model update metadata during federated learning.

In centralized machine learning in which a machine learning model is trained using a single computing device, progress in training a machine learning model is monitored by periodically measuring evaluation metrics, such as training loss and task accuracy (e.g., classification accuracy). However, in federated learning, where model training is performed by federated learning clients using local data that is not shared with a training coordinator (e.g., a federated learning server) or other centralized system, no data is available at the training coordinator, and consequently conventional training metrics like training loss and task accuracy cannot be computed at the training coordinator. While these training metrics can be computed by the federated learning clients, where the training data is available, such local metrics alone cannot be used to determine the quality of the training of the global model and/or to determine when to stop the training. As such, training may end too quickly, resulting in suboptimal models (e.g., models that are overfit or underfit to the training data and thus fail to generalize the training data into a usable model that generates usable inferences for data different from the training data), or training may go on too long, resulting in lost resources (e.g., unnecessary use of power, compute resources, networking bandwidth, and the like).

To allow for machine learning models to be trained using federated learning techniques that satisfy various inference performance characteristics (e.g., classification accuracy), aspects described herein include sending local training metrics from federated learning clients to a training coordinator so that the metrics may be aggregated and may provide a view of the global model training quality. In some aspects, the local evaluation metrics are computed by the federated learning clients using validation data on the same device where the local model was trained. These local evaluation metrics may then be sent to the training coordinator by the federated learning clients as training metadata along with model update data (e.g., synchronously). In other aspects, the training metadata may be sent separately from the model update data based on availability. In various aspects, the local evaluation metrics can be aggregated (e.g., averaged) by the training coordinator to produce evaluation metrics that provide an overall measure of the training quality of the global model, which improves determination of successful federated learning.

During the training process, local metadata, such as local training loss, local training accuracy and local validation accuracies, are reported back by every device to the coordinator server.

Aspects described herein thus improve the federated learning process as well as the resulting models generated by federated learning. For example, during training, the aggregated local evaluation metrics allow for improved determination of global model performance and improved control over when to stop the federated learning process, thereby saving significant resources that may otherwise be wasted due to the execution of unnecessary training epochs for the global model. Further, the resulting models may generally have better performance (e.g., classification accuracy or other inference performance) owing to better control of the training process using the aggregated local evaluation metrics. Such models may be used for a wide variety of machine learning model (or artificial intelligence) tasks, such as (but not limited to) image classification based on local image data, sound classification based on local sound data, and authentication based on local biometric data. Notably, these are just a few examples, and others are possible.

### Brief Overview of Federated Learning

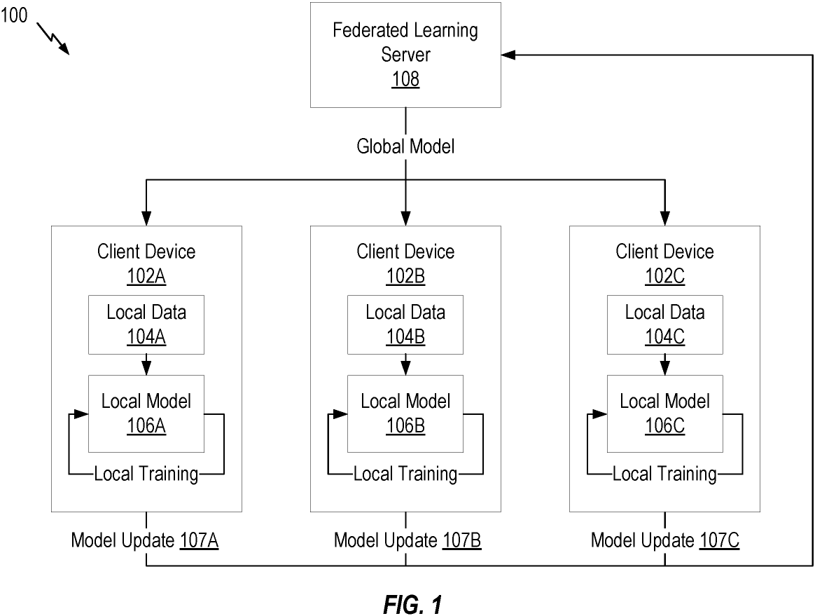

FIG. 1 depicts an example federated learning architecture 100.

In this example, client devices 102A-C (which may be collectively referred to as client device(s) 102) each have a local data store storing local data 104A-C, respectively, and a local machine learning model instance 106A-C, respectively. For example, the client device 102A comes with an initial machine learning model instance 106A (or receives an initial machine learning model instance 106A from, for example, a federated learning server 108). Each of the client devices 102A-C may use its respective machine learning model instance 106A-C for some useful task, such as processing local data 104A-C, and further perform local training and optimization of its respective machine learning model instance (referred to as a local machine learning model instance).

For example, the client device 102A may use its local machine learning model instance 106A for performing facial recognition on pictures stored as data 104A on the client device 102A. Because these photos may be considered private, the client device 102A may not share, or may be prevented from sharing, its photo data with the federated learning server 108. However, the client device 102A may be willing or permitted to share its local model updates 107A, such as updates to model weights and parameters, with the federated learning server 108. Similarly, the client devices 102B and 102C may use their respective local machine learning model instances 106B and 106C in the same manner and also share their respective local model updates 107B and 107C with the federated learning server 108 without sharing the underlying data (e.g., local data 104B and local data 104C, respectively) used to generate the local model updates.

The federated learning server 108 (alternatively referred to as a global model coordinator or central server) may use all of the local model updates 107 to determine a global (or consensus) model update, which may then be distributed to the client devices 102A-C. In this way, machine learning can leverage the client devices 102A-C without centralizing training data and processing.

Thus, the federated learning architecture 100 allows for decentralized deployment and training of machine learning models.

In some aspects, federated learning may be implemented using a FedAvg algorithm. In federated learning using a FedAvg algorithm, the model may be trained using a plurality of communication rounds. At each communication round t executed while training a model using the FedAvg algorithm, a server (e.g., the federated learning server 108 in FIG. 1) sends the current model parameters w^{(t)} to at least a subset S′ of all S clients participating in training (e.g., the client devices 102A, 102B, and/or 102C in FIG. 1). Each client s in the subset updates the server-provided model w^{(t)}, for example, via stochastic gradient descent, to better fit its local dataset dₛ (e.g., data 104A, 104B, and/or 104C, respectively, in FIG. 1) of size Nₛ using a given loss function, such as:

$${L}_{s} \left({D}_{s} , {\text{w}}^{\left(\text{t}\right)}\right) : = \frac{1}{{N}_{s}} {\sum }_{i = 1}^{{N}_{s}} L \left({d}_{s i} , {\text{w}}^{\left(\text{t}\right)}\right) \qquad \text{(1)}$$

where ℒₛ represents a loss to be minimized (or at least reduced) while training the model, and dₛᵢ represents the local data dₛ for the i^{th} client device in the subset S′ of client devices participating in training the model.

After E epochs of optimization on the local dataset, the client-side optimization procedure results in an updated model

$${\text{w}}_{s}^{\left(t\right)} ,$$

based on which the client computes its update to the global model according to:

$${\text{Δ}}_{s}^{\left(t\right)} = {\text{w}}_{s}^{\left(t\right)} - {\text{w}}^{\left(t\right)} \qquad \text{(2)}$$

and communicates this update to the server.

$${\text{Δ}}_{s}^{\left(t\right)}$$

generally represents the difference between the model parameters generated based on training the model using the local data set (e.g., the parameters of the update model

$$\left({w}_{s}^{\left(t\right)}\right)$$

and the model parameters w^{(t)} provided to the client device prior to training the model using the local data at the client device. The server then aggregates the client-specific updates to receive the new global model at the next communication round t+1 according to:

$${\text{w}}^{\left(t + 1\right)} = {\text{w}}^{\left(t\right)} + \frac{1}{\left|{S}^{′}\right|} {\sum }_{s} {\text{Δ}}_{s}^{\left(t\right)} = \frac{1}{\left|{S}^{′}\right|} {\sum }_{s} {\text{w}}_{s}^{\left(t\right)} \qquad \text{(3)}$$

A generalization of this server-side averaging scheme interprets

$$\frac{1}{{S}^{′}} {\sum }_{s} {\text{Δ}}_{s}^{\left(t\right)}$$

as a “gradient” for the server-side model and enables more advanced updating schemes, such as adaptive momentum (e.g., the Adam algorithm). However, in other aspects, federated learning may be implemented using one or more other suitable algorithms.

### Training Metadata Computation in Federated Learning

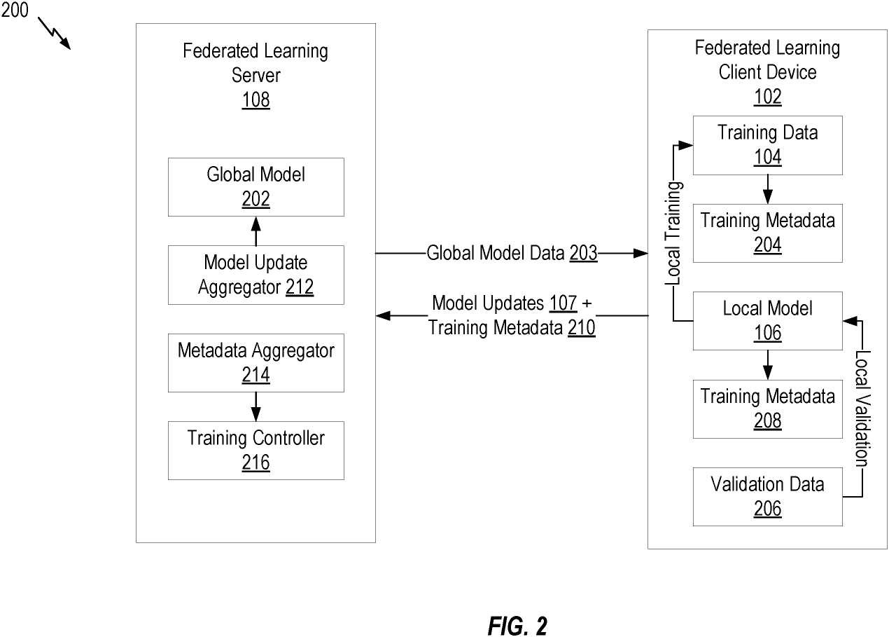

FIG. 2 depicts an example of generating training metadata during federated learning conducted between the federated learning server 108 and a federated learning client device 102 (e.g., client device 102A-102C). Generally, a federated learning server may be any sort of server or other computing device that is configured to manage training of a global model using remote training resources, such as the federated learning client device(s) 102A-102C illustrated in FIG. 1. Similarly, a federated learning client device 102 is generally a device configured to receive data from a federated learning server and to perform local training of a model based on that data using local data, such as generally described with respect to FIG. 1.

In the depicted example, the federated learning server 108 sends global model data 203 to the federated learning client device 102. The global model data 203 may comprise an entire global model (e.g., all of the parameters for a machine learning model, such as weights, biases, architecture, etc.) or a set of model updates that allows federated learning client device 102 to update an existing model.

The federated learning client device 102 may use the received global model data 203 to construct or update the local model 106 and thereafter to perform local training with the training data 104. For example, the training data 104 may be any data stored on the federated learning client device 102 or otherwise directly accessible to the federated learning client device 102. A result of the local training is training metadata 204. In some aspects, the training metadata 204 may include (but is not limited to) one or more training loss values (e.g., generated by a loss function during training), and/or one or more model performance metrics, such as (but not limited to) accuracy, true positive rate (TPR), false positive rate (FPR), receiver operating characteristic (ROC) curves, area under ROC curve (AUC) curves, false recognition rate (FRR), and others.

The federated learning client device 102 may further perform validation testing using validation data 206 in order to generate training metadata 208, which may include one or more model performance metrics, such as those mentioned above in reference to the training metadata 204. Validation data 206 may, in some aspects, be local data stored at the federated learning client device 102 which is used to validate the performance of the local model 106. Generally, validation data 206 may include a known label or classification associated with each input data set of a plurality of input data sets, and the task of the local model 106 is to generate an inference that matches the known label or classification for a given input data set from the plurality of data sets. For example, inference performance metrics, such as accuracy, false acceptance rates, false rejection rates, and the like can be obtained based on differences between labels assigned to input data sets in an input. Other inference performance metrics, such as inference time or he like may be measured based on performing inferences on validation data 206 before using the local model 106 to process a subsequent inference on another data set in validation data 206.

The federated learning client device 102 may then send any model updates 107 based on local training as well as training metadata 210 (e.g., 204 and/or 208) based on local training and/or local validation to the federated learning server 108. The federated learning server 108 in turn may aggregate model updates from a plurality of federated learning client devices (e.g., one or more federated learning client devices 102) using a model update aggregator 212. Then, the federated learning server 108 may update the global model 202 accordingly.

Further, the federated learning server 108 may aggregate any training metadata from a plurality of federated learning client devices (e.g., one or more federated learning client devices 102) using a metadata aggregator 214. The aggregated training metadata may then be provided to a training controller 216 to determine, for example, the current performance of the global model based on the aggregated metadata. Further, the training controller 216 may determine whether or not to continue training based on the aggregated metadata. For example, if the aggregated metadata shows that the global model is performing at or above a performance threshold, then the training controller 216 may discontinue federated learning, thereby freeing up compute resources and saving networking resources. In some aspects, the server 108 may not need to update the global model 202 with the model updates associated with the training metadata. Conversely, if the aggregated metadata shows that the global model is performing below a performance threshold, then the training controller 216 may continue federated training, thereby ensuring the final global model meets performance objectives.

In some aspects, the training controller 216 may decide to continue or discontinue federated learning based on a gradient of a performance metric, such as (but not limited to) those described above. In this way, as the performance of the global model 202 starts to converge, training may be discontinued without performing additional training epochs that add little to the performance of the ultimate global model.

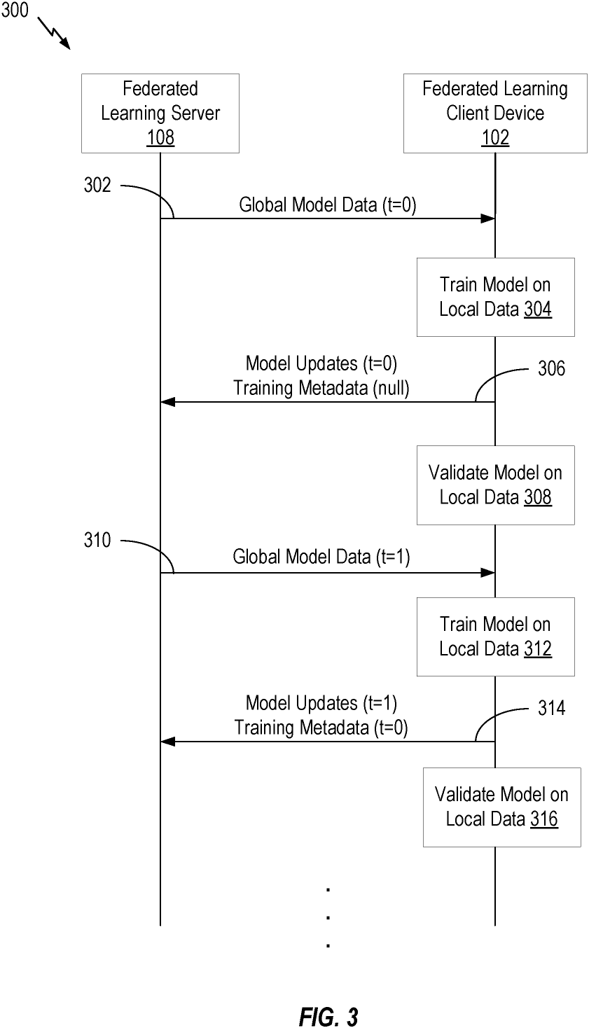

Note that while shown as a synchronous transmission of model update and training metadata at 210, as described with respect to FIG. 3, such transmissions may be asynchronous, such as where model update data is sent first followed by training metadata when the training metadata becomes available.

### Pipelined Federated Learning With Training Metadata Generation

FIG. 3 depicts an example process 300 of pipelining federated learning when generating training metadata.

Because generating certain training metadata, such as validation data using a local validation dataset, takes time, it may be beneficial to send model update data as soon as local training is complete, and then to follow with training metadata (e.g., based on local training and/or local validation) as soon as this metadata is generated. In this way, a federated learning server 108 can increase the speed at which the server is pushing out model updates to the federated learning client devices (e.g., one or more federated learning client devices 102) without waiting on the training metadata.

Accordingly, as depicted in FIG. 3, the federated learning server 108 may initially send global model data (e.g., a model, or updates to a model) to a federated learning client device 102 at transmission 302. In this example, the global model data may be indexed as t = 0, for example referring to a first training iteration.

At block 304, the federated learning client device 102 trains a local model based on the global model data received at transmission 302 and using local data.

At transmission 306, the federated learning client device 102 sends model update data to the federated learning server 108. In this example, the model update data is indexed as t = 0, referring to the first training iteration. Because at this time the federated learning client device 102 has not yet performed model validation after training at block 304, there is not yet local validation-based training metadata (e.g., training metadata 208 in FIG. 2) available to be sent to the federated learning server 108. There may, however, be local training-based metadata (e.g., training metadata 204 in FIG. 2) at this time.

In this example, the federated learning client device 102 waits to send training metadata to the federated learning server 108 until all training metadata based on the global model data indexed at t = 0 is available. Therefore, in some aspects, the metadata update at transmission 306 may be depicted as “null.” This “null” indication assumes a predefined data exchange format (e.g., a message format) that is configured to include both model update data and training metadata, and thus, since no training metadata is sent, the metadata update is marked as null. However, in other cases, this may not be necessary. That is, model updates and training metadata may be sent in unstructured data formats.

At block 308, the federated learning client device 102 performs model validation using local validation data. The result of this validation data may be training metadata, such as training metadata 208 in FIG. 2.

At transmission 310, the federated learning server 108 sends global model data (indexed as t = 1), and thus represents the next training iteration, which began in this example while the federated learning client device 102 was still performing validation on the global model indexed as t = 0. Thus, the pipelining creates an interleaving of model updates, model validation, and training metadata generation and exchange during the overall federated learning process.

At block 312, the federated learning client device 102 trains its local model based on global model data received at transmission 310 and local training data at the federated learning client device 102.

At block 314, the federated learning client device 102 sends model updates based on the global model data received at transmission 310 (indexed as t = 1) and sends training metadata based on the global model data received at transmission 302 (indexed as t = 0). Thus, the sending of model update data and training metadata may be described as asynchronous since the federated learning client device 102 sends model update data at one time and training metadata associated with the model update at a second time, later than the first time in this example.

At block 316, the federated learning client device 102 performs model validation using local validation data. In this case, the model validation is performed based on the global model data received at transmission 310 (indexed as t = 1).

The process 300 may continue iteratively until the federated learning server 108 determines to discontinue training (e.g., when the performance metrics for the global model converge, when model performance (e.g., inference accuracy) reaches a threshold level, etc.).

In this example, the federated learning client device 102 sends model updates based on the global model data received at transmission 310 (indexed as t = X) and sends training metadata based on the global model data received at transmission 302 (indexed as t = X - 1). In other aspects, the index difference may be separated by more than one transmission.

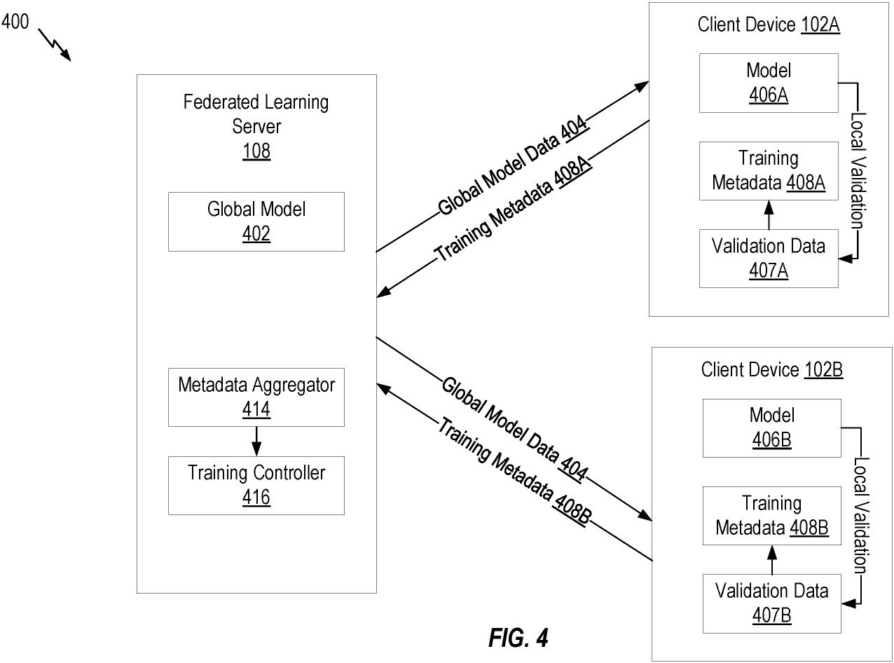

FIG. 4 depicts an example process 400 for generating training metadata using client devices 102A, 102B that perform model validation. In this example, the client devices may generate training metadata based on local data but may not participate in training the machine learning model (e.g., generating updates to the machine learning model using local data and providing such updates to a federated learning server for aggregation or inclusion into the global model).

In particular, in this example, the federated learning server 108 sends global model data 404 defining the current state of the global model 402 (e.g., global model 202) to the client devices 102A and 102B. Each of the client devices 102A and 102B performs local validation using local models 406A and 406B and local validation data 407A and 407B, respectively. The client devices 102A and 102B send the resulting training metadata 408A and 408B generated based on local validation of the global model 402 to the federated learning server 108. The federated learning server 108 may subsequently aggregate the training metadata via a metadata aggregator 414 (e.g., metadata aggregator 214) and provide the aggregated training metadata to a training controller 416 (e.g., training controller 216) so that the federated learning server 108 and/or the training controller 416 may decide whether to continue training.

Note, in this example, the client devices 102A and 102B are used only for local validation and generation of training metadata (e.g., model performance metrics, such as those discussed above) based on the validation. However, the client devices 102A and 102B may have previously, or may in the future, participate in local training as well as local validation, such as in the example described with respect to FIG. 2. A benefit of using validation-only client devices for federated learning is increasing the speed of testing the global model 402 on a wide range of client-device-specific data sets. As discussed with respect to FIG. 3, because validation may take additional time, which delays transmission of training metadata to the federated learning server 108, using validation-only client devices may reduce the latency of generating the training metadata.

### Methods of Performing Federated Learning With Training Metadata

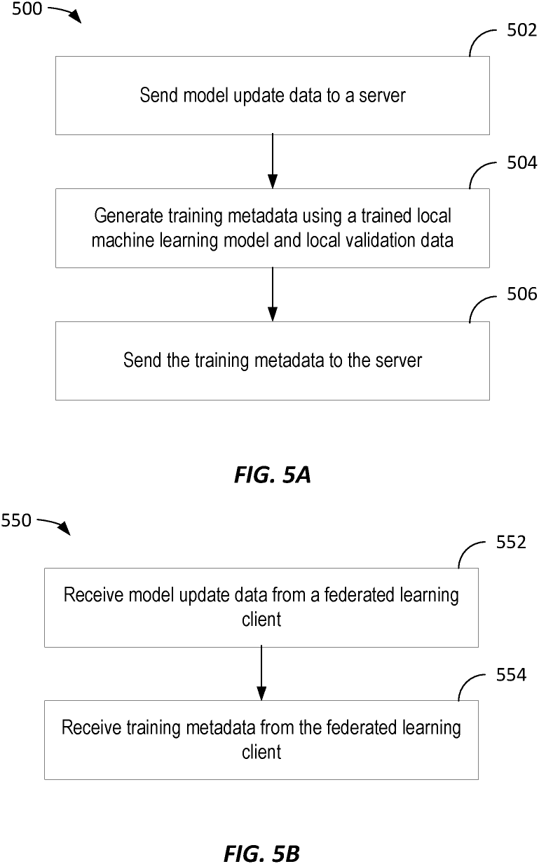

FIG. 5A depicts an example method 500 of performing federated learning with training metadata. In some aspects, method 500 may be performed by a federated learning client device, as described above with respect to FIGS. 1-4.

At block 502, a client device may send model update data to a server, such as (but not limited to) depicted and described with respect to FIGS. 2 and 3.

Method 500 then proceeds to block 504 with generating, by the client device, training metadata using a trained local machine learning model and local validation data, such as (but not limited to) depicted and described with respect to FIGS. 2 and 3. In some aspects, the trained local machine learning model incorporates the model update data and global model data defining a global machine learning model. The training metadata may generally include data about the trained local machine learning model used to determine when to discontinue federated learning operations for training the global machine learning model.

Method 500 then proceeds to block 506 with sending, by the client device, the training metadata to the server, such as (but not limited to) described with respect to FIGS. 2-4.

In some aspects, method 500 further includes receiving, by the client device, global model data from the server, such as (but not limited to) described with respect to FIGS. 2 and 3.

In some aspects, method 500 further includes generating, by the client device, the local machine learning model based on the global model data, such as (but not limited to) described with respect to FIGS. 2 and 3.

In some aspects, method 500 further includes training, by the client device, the local machine learning model using local training data to generate model update data, such as (but not limited to) described with respect to FIGS. 2 and 3.

In some aspects, the model update data and the training metadata are sent by the client device to the server synchronously, such as (but not limited to) described with respect to FIG. 2. In other aspects, the model update data and the training metadata are sent by the client device to the server asynchronously, such as (but not limited to) described with respect to FIG. 3.

In some aspects, the updated global model data may be received, by the client device, from the server prior to sending the training metadata to the server, such as (but not limited to) described with respect to FIG. 3.

In some aspects, the training metadata includes one or more of a first accuracy value based on testing the trained local model with the local training data or a loss value associated with training the local model based on the local training data. The training metadata generally includes a second accuracy value associated with testing the trained local model using the local validation data.

In some aspects, method 500 further includes receiving, by the client device, updated global model data from the server and processing local data with an updated global machine learning model based on the updated global model to perform a task. In some aspects, the task comprises one of: image classification based on local image data; sound classification based on local sound data; or authentication based on local biometric data.

Though not depicted in FIG. 5A, in some aspects, block 502 may be omitted, such as when a federated learning client device is performing local validation only, as described (but not limited to) with respect to FIG. 4.

Note that FIG. 5A is just one example of a method, and other methods including fewer, additional, or alternative operations are possible consistent with this disclosure.

FIG. 5B depicts an example method 550 of performing federated learning with training metadata. In some aspects, method 500 may be performed by a federated learning server, as described above (but not limited to) with respect to FIGS. 1-4.

St block 552, the server may receive model update data from a federated learning client, such as (but not limited to) depicted and described with respect to FIGS. 2 and 3.

Method 550 then proceeds to block 554 with receiving, by the server, training metadata from the federated learning client, such as (but not limited to) depicted and described with respect to FIGS. 2-4. The training metadata generally includes data about a trained local machine learning model incorporating the model update data at the federated learning client. This training metadata may generally be used to determine when to discontinue federated learning operations for training a global machine learning model.

In some aspects, the model update data and the training metadata are received by the server synchronously. In other aspects, the model update data and the training metadata are received by the server asynchronously.

In some aspects, method 550 further includes sending, by the server, data defining the global machine learning model to the federated learning client, such as (but not limited to) depicted and described with respect to FIGS. 2 and 3.

In some aspects, method 550 further includes updating, by the server, the global machine learning model at least in part based on the model update data from the federated learning client, such as (but not limited to) depicted and described with respect to FIGS. 2 and 3.

In some aspects, method 550 further includes sending, by the server, data defining the updated global machine learning model to the federated learning client prior to receiving the training metadata from the federated learning client, such as (but not limited to) depicted and described with respect to FIG. 3.

In some aspects, the training metadata comprises one or more of a first accuracy value of a federated learning client local model trained with federated learning client local training data or a loss value associated with the federated learning client local model based on the federated learning client local training data. In some aspects, the training metadata generally includes a second accuracy value of the federated learning client local model tested with federated learning client local validation data.

In some aspects, method 550 further includes determining, by the server, to continue or to discontinue training of the global model based at least in part on the training metadata, such as (but not limited to) described with respect to FIGS. 2 and 3.

In some aspects, method 550 further includes aggregating, by the server, the training metadata received from the federated learning client with additional training metadata received from one or more other federated learning clients; and determining, by the server, to continue or to discontinue training of the global machine learning model based at least in part on the aggregated training metadata, such as (but not limited to) described with respect to FIGS. 2 and 3.

Though not depicted in FIG. 5B, in some aspects, block 552 may be omitted, such as when receiving training metadata from a federated learning client device performing local validation only, as described with respect to FIG. 4.

Note that FIG. 5B is just one example of a method, and other methods including fewer, additional, or alternative operations are possible consistent with this disclosure.

### Example Processing System for Federated Learning With Metadata Generation

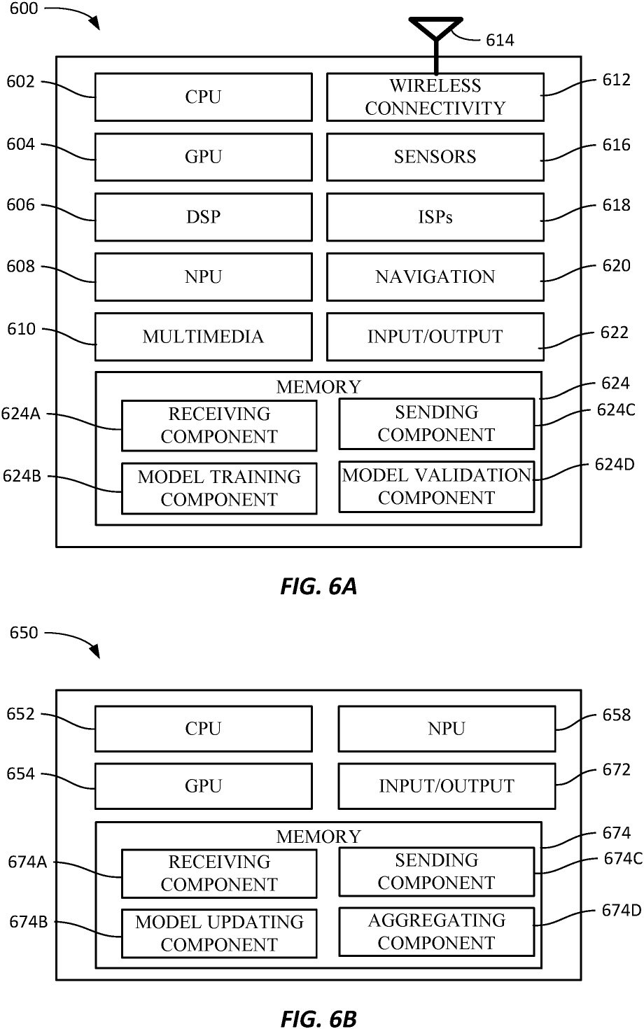

FIG. 6A depicts an example processing system 600 for performing federated learning, such as described herein for example with respect to FIG. 1-5A. Processing system 600 may be an example of a federated learning client device, such as federated learning client device 102 in FIGS. 2-4.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), a tensor processing unit (TPU), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error. In some cases, an NPU may be configured to perform the federated learning methods described herein.

NPUs designed to accelerate inference are generally configured to operate on complete models. Such NPUs may thus be configured to input a new piece of data and rapidly process this new piece through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 612 is further connected to one or more antennas 614. In some examples, wireless connectivity component 612 allows for performing federated learning according to methods described herein over various wireless data connections, including cellular connections.

Processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes receiving component 624A, model training component 624B, sending component 624C, and model validation component 624D. The depicted components, and others not depicted, may be configured to perform various aspects of the methods described herein.

Generally, processing system 600 and/or components thereof may be configured to perform the methods described herein.

Notably, in other cases, aspects of processing system 600 may be omitted or added. For example, multimedia processing unit 610, wireless connectivity component 612, sensor processing units 616, ISPs 618, and/or navigation component 620 may be omitted in other aspects. Further, aspects of processing system 600 may be distributed between multiple devices.

FIG. 6B depicts another example processing system 650 for performing federated learning, such as described herein for example with respect to FIGS. 1-4 and 5B. Processing system 650 may be an example of a federated learning server, such as federated learning server 108 in FIGS. 2-4.

Generally, CPU 652, GPU 654, NPU 658, and input/output 672 are as described above with respect to like elements in FIG. 6A.

Processing system 650 also includes memory 674, which is representative of one or more static and/or dynamic memories, such as a dynamic random access memory, a flash-based static memory, and the like. In this example, memory 674 includes computer-executable components, which may be executed by one or more of the aforementioned processors of processing system 650.

In particular, in this example, memory 674 includes receiving component 674A, model updating component 674B, sending component 674C, and aggregating component 674D. The depicted components, and others not depicted, may be configured to perform various aspects of the methods described herein.

Generally, processing system 650 and/or components thereof may be configured to perform the methods described herein.

Notably, in other cases, aspects of processing system 650 may be omitted or added. Further, aspects of processing system 650 may be distributed between multiple devices, such as in a cloud-based service. The depicted components are limited for clarity and brevity.

### EXAMPLE CLAUSES

Implementation details of various aspects of the present disclosure are described in the following numbered clauses:

Clause 1: A computer-implemented method, comprising: sending model update data to a server; generating training metadata using a trained local machine learning model and local validation data, wherein: the trained local machine learning model incorporates the model update data and global model data defining a global machine learning model, and the training metadata comprises data about the trained local machine learning model used to determine when to discontinue federated learning operations for training the global machine learning model; and sending the training metadata to the server.

Clause 2: The method of Clause 1, further comprising: receiving global model data from the server; generating the local machine learning model based on the global model data; and training the local machine learning model using local training data to generate model update data.

Clause 3: The method of Clause 2, wherein the model update data and the training metadata are sent to the server synchronously.

Clause 4: The method of Clause 2, wherein the model update data and the training metadata are sent to the server asynchronously.

Clause 5: The method of Clause 2, further comprising receiving updated global model data from the server prior to sending the training metadata to the server.

Clause 6: The method of any of Clauses 2-5, wherein: the training metadata comprises one or more of: a first accuracy value based on testing the trained local model with the local training data; and a loss value associated with training the local model based on the local training data, and the training metadata comprises a second accuracy value associated with the testing the trained local model using the local validation data.

Clause 7: The method of any of Clauses 2-6, further comprising: receiving updated global model data from the server; and processing local data with an updated global machine learning model based on the updated global model to perform a task.

Clause 8: The method of Clause 7, wherein the task comprises one of: image classification based on local image data; sound classification based on local sound data; or authentication based on local biometric data.

Clause 9: A computer-implemented method, comprising: receiving model update data from a federated learning client; and receiving training metadata from the federated learning client, wherein the training metadata comprises data about a trained local machine learning model incorporating the model update data at the federated learning client used to determine when to discontinue federated learning operations for training a global machine learning model.

Clause 10: The method of Clause 9, wherein the model update data and the training metadata are received synchronously.

Clause 11: The method of Clause 9, wherein the model update data and the training metadata are received asynchronously.

Clause 12: The method of Clause 9, further comprising: sending data defining the global machine learning model to the federated learning client; updating the global machine learning model at least in part based on the model update data from the federated learning client; and sending data defining the updated global machine learning model to the federated learning client prior to receiving the training metadata from the federated learning client.

Clause 13: The method of any of Clauses 9-12, wherein: the training metadata comprises one or more of: a first accuracy value of a federated learning client local model trained with federated learning client local training data; and a loss value associated with the federated learning client local model based on the federated learning client local training data, and the training metadata comprises a second accuracy value of the federated learning client local model tested with federated learning client local validation data.

Clause 14: The method of any of Clauses 9-13, further comprising determining to continue or to discontinue training of the global machine learning model based at least in part on the training metadata.

Clause 15: The method of any of Clauses 9-14, further comprising aggregating the training metadata received from the federated learning client with additional training metadata received from one or more other federated learning clients.

Clause 16: The method of Clause 15, further comprising determining to continue or to discontinue training of the global machine learning model based at least in part on the aggregated training metadata.

Clause 17: A computer-implemented method, comprising: generating training metadata using a global model and local validation data; and sending the training metadata to a server, wherein the training metadata comprises data about the global machine learning model used to determine when to discontinue federated learning operations for training the global machine learning model.

Clause 18: The method of Clause 17, wherein the training metadata comprises an accuracy value associated with testing the global model using the local validation data.

Clause 19: The method of any of Clauses 17-18, further comprising: receiving the global machine learning model from the server; receiving updated global machine learning model data from the server; and processing local data with an updated global machine learning model based on the updated global machine learning model data model to perform a task.

Clause 20: The method of Clause 19, wherein the task comprises one of: image classification based on local image data; sound classification based on local sound data; or authentication based on local biometric data.

Clause 21: A computer-implemented method, comprising: sending a global machine learning model to a federated learning client device; and receiving training metadata from the federated learning client device, wherein the training metadata comprises data about a trained local machine learning model used to determine when to discontinue federated learning operations for training the global machine learning model.

Clause 22: The method of Clause 21, wherein the training metadata comprises an accuracy value associated with a federated learning client local model tested with federated learning client local validation data.

Clause 23: The method of any of Clauses 21-22, further comprising determining to continue or to discontinue training of the global machine learning model based at least in part on the training metadata.

Clause 24: The method of any of Clauses 21-23 further comprising: aggregating the training metadata received from the federated learning client with additional training metadata received from one or more other federated learning clients; and determining to continue or to discontinue training of the global machine learning model based at least in part on the aggregated training metadata.

Clause 25: A processing system, comprising: a memory comprising computer-executable instructions; and a processor configured to execute the computer-executable instructions and cause the processing system to perform a method in accordance with any of Clauses 1-24.

Clause 26: A processing system, comprising means for performing a method in accordance with any of Clauses 1-24.

Clause 27: A non-transitory computer-readable medium comprising computer-executable instructions that, when executed by a processor of a processing system, cause the processing system to perform a method in accordance with any of Clauses 1-24.

Clause 28: A computer program product embodied on a computer-readable storage medium comprising code for performing a method in accordance with any of Clauses 1-24.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
sending, by a client device, model update data to a server;
generating, by the client device, training metadata using a trained local machine learning model and local validation data, wherein:
the trained local machine learning model incorporates the model update data and global model data defining a global machine learning model, and
the training metadata comprises data about the trained local machine learning model used to determine when to discontinue federated learning operations for training the global machine learning model; and sending, by the client device, the training metadata to the server.

2. The method of claim 1, further comprising:
receiving, by the client device, the global model data from the server;
generating, by the client device, the local machine learning model based on the global model data; and
training, by the client device, the local machine learning model using local training data to generate the model update data.

3. The method of claim 2, wherein the model update data and the training metadata are sent to the server synchronously.

4. The method of claim 2, further comprising receiving, by the client device, updated global model data from the server prior to sending the training metadata to the server.

5. The method of claim 2, wherein:
the training metadata comprises one or more of:
(i) a first accuracy value based on testing the trained local machine learning model with the local training data, or
(ii) a loss value associated with training the local machine learning model based on the local training data; and
the training metadata comprises a second accuracy value associated with testing the trained local machine learning model using the local validation data.

6. The method of claim 2, further comprising:
receiving, by the client device, updated global model data from the server; and
processing, by the client device, local data with an updated global machine learning model based on the updated global model data to perform a task.

7. The method of claim 6, wherein the task comprises one of:
image classification based on local image data;
sound classification based on local sound data; or
authentication based on local biometric data.

8. A computer-implemented method, comprising:
receiving, by a server, model update data from a federated learning client; and
receiving, by a server, training metadata from the federated learning client,
wherein the training metadata comprises data about a trained local machine learning model incorporating the model update data at the federated learning client used to determine when to discontinue federated learning operations for training a global machine learning model.

9. The method of claim 8, wherein the model update data and the training metadata are received synchronously.

10. The method of claim 8, further comprising:
sending, by the server, data defining the global machine learning model to the federated learning client;
updating, by the server, the global machine learning model at least in part based on the model update data from the federated learning client; and
sending, by the server, data defining the updated global machine learning model to the federated learning client prior to receiving the training metadata from the federated learning client.

11. The method of claim 8, wherein:
the training metadata comprises one or more of:
(i) a first accuracy value of a federated learning client local machine learning model trained with federated learning client local training data; or
(ii) a loss value associated with the federated learning client local machine learning model based on the federated learning client local training data; and
the training metadata comprises a second accuracy value of the federated learning client local machine learning model tested with federated learning client local validation data.

12. The method of claim 8, further comprising determining, by the server, to continue or to discontinue training of the global machine learning model based at least in part on the training metadata.

13. The method of claim 8, further comprising aggregating, by the server, the training metadata received from the federated learning client with additional training metadata received from one or more other federated learning clients.

14. The method of claim 13, further comprising determining, by the server, to continue or to discontinue training of the global machine learning model based at least in part on the aggregated training metadata.

15. A computer-implemented method, comprising:
generating, by a client device, training metadata using a global machine learning model and local validation data; and
sending, by the client device, the training metadata to a server, wherein the training metadata comprises data about the global machine learning model used to determine when to discontinue federated learning operations for training the global machine learning model.

16. The method of claim 15, wherein the training metadata comprises an accuracy value associated with testing the global machine learning model using the local validation data.

17. The method of claim 15, further comprising:
receiving, by the client device, the global machine learning model from the server;
receiving, by the client device, updated global machine learning model data from the server; and
processing, by the client device, local data with an updated global machine learning model based on the updated global machine learning model data to perform a task.

18. The method of claim 17, wherein the task comprises one of:
image classification based on local image data;
sound classification based on local sound data; or
authentication based on local biometric data.

19. A computer-implemented method, comprising:
sending, by a server, a global machine learning model to a federated learning client device; and
receiving, by the server, training metadata from the federated learning client device, wherein the training metadata comprises data about a trained local machine learning model used to determine when to discontinue federated learning operations for training the global machine learning model.

20. The method of claim 19, wherein the training metadata comprises an accuracy value associated with a federated learning client local model tested with federated learning client local validation data.

21. The method of claim 19, further comprising determining, by the server, to continue or to discontinue training of the global machine learning model based at least in part on the training metadata.

22. The method of claim 19, further comprising:
aggregating, by the server, the training metadata received from the federated learning client device with additional training metadata received from one or more other federated learning client devices; and
determining, by the server, to continue or to discontinue training of the global machine learning model based at least in part on the aggregated training metadata.

23. A system, comprising:
a memory comprising computer-executable instructions; and
a processor configured to execute the computer-executable instructions in order to cause the system to:
send model update data to a server;
generate training metadata using a trained local machine learning model and local validation data, wherein:
the trained local machine learning model incorporates the model update data and global model data defining a global machine learning model, and
the training metadata comprises data about the trained local machine learning model used to determine when to discontinue federated learning operations for training the global machine learning model; and
send the training metadata to the server.

24. The system of claim 23, wherein the processor is further configured to cause the system to:
receive the global model data from the server;
generate the local machine learning model based on the global model data; and
train the local machine learning model using local training data to generate the model update data.

25. The system of claim 24, wherein the model update data and the training metadata are sent to the server asynchronously.

26. The system of claim 24, wherein the processor is configured to cause the system to receive updated global model data from the server prior to sending the training metadata to the server.

27. The system of claim 24, wherein:
the training metadata comprises one or more of:
(i) a first accuracy value based on testing the trained local machine learning model with the local training data, or
(ii) a loss value associated with training the local machine learning model based on the local training data; and
the training metadata comprises a second accuracy value associated with testing the trained local machine learning model using the local validation data.

28. The system of claim 24, wherein the processor is further configured to cause the system to:
receive updated global model data from the server; and
process local data with an updated global machine learning model based on the updated global model data to perform a task.

29. The system of claim 28, wherein the task comprises one of:
image classification based on local image data;
sound classification based on local sound data; or
authentication based on local biometric data.

30. A system, comprising:
a memory having executable instructions stored thereon; and
a processor configured to execute the executable instructions in order to cause the system to:
receive model update data from a federated learning client; and
receive training metadata from the federated learning client,
wherein the training metadata comprises data about a trained local machine learning model incorporating the model update data at the federated learning client used to determine when to discontinue federated learning operations for training a global machine learning model.

31. The system of claim 30, wherein the model update data and the training metadata are received synchronously.

32. The system of claim 30, wherein the processor is further configured to cause the system to:
send, by the server, data defining the global machine learning model to the federated learning client;
update, by the server, the global machine learning model at least in part based on the model update data from the federated learning client; and
send, by the server, data defining the updated global machine learning model to the federated learning client prior to receiving the training metadata from the federated learning client.

33. The system of claim 30, wherein:
the training metadata comprises one or more of:
(i) a first accuracy value of a federated learning client local machine learning model trained with federated learning client local training data; or
(ii) a loss value associated with the federated learning client local machine learning model based on the federated learning client local training data; and
the training metadata comprises a second accuracy value of the federated learning client local machine learning model tested with federated learning client local validation data.

34. The system of claim 30, wherein the processor is further configured to cause the system to determine to continue or to discontinue training of the global machine learning model based at least in part on the training metadata.

35. The system of claim 30, wherein the processor is further configured to cause the system to aggregate, by the server, the training metadata received from the federated learning client with additional training metadata received from one or more other federated learning clients.

36. The system of claim 35, wherein the processor is further configured to cause the system to determine to continue or to discontinue training of the global machine learning model based at least in part on the aggregated training metadata.

37. A system, comprising:
a memory having executable instructions stored thereon; and
a processor configured to execute the executable instructions in order to cause the system to:
generate, by a client device, training metadata using a global machine learning model and local validation data; and
send, by the client device, the training metadata to a server, wherein the training metadata comprises data about the global machine learning model used to determine when to discontinue federated learning operations for training the global machine learning model.

38. The system of claim 37, wherein the training metadata comprises an accuracy value associated with testing the global machine learning model using the local validation data.

39. The system of claim 37, wherein the processor is further configured to: receive the global machine learning model from the server;
receive updated global machine learning model data from the server; and
process local data with an updated global machine learning model based on the updated global machine learning model data to perform a task.

40. The system of claim 39, wherein the task comprises one of:
image classification based on local image data;
sound classification based on local sound data; or
authentication based on local biometric data.

41. A system, comprising:
a memory having executable instructions stored thereon; and
a processor configured to execute the executable instructions in order to cause the system to:
send, by a server, a global machine learning model to a federated learning client device; and
receive, by the server, training metadata from the federated learning client device, wherein the training metadata comprises data about a trained local machine learning model used to determine when to discontinue federated learning operations for training the global machine learning model.

42. The system of claim 41, wherein the training metadata comprises an accuracy value associated with a federated learning client local model tested with federated learning client local validation data.

43. The system of claim 41, where in the process or is further configured to determine to continue or to discontinue training of the global machine learning model based at least in part on the training metadata.

44. The system of claim 41, wherein the processor is further configured to cause the system to:
aggregate the training metadata received from the federated learning client device with additional training metadata received from one or more other federated learning client devices; and
determine to continue or to discontinue training of the global machine learning model based at least in part on the aggregated training metadata.
